(19) United States
(12) Patent Application Publication
(10) Pub. No.: US 2012/0134499 A1
(43) Pub. Date: May 31, 2012

(54) Audio Processing Devices, Multi-Channel Audio Application System, and Method Thereof

(75) Inventor: Meng-Chieh Chuang, Taipei Hsien (TW)

(73) Assignee: ACER INCORPORATED, Taipei Hsien (TW)

(21) Appl. No.: 13/073,885

(22) Filed: Mar. 28, 2011

(30) Foreign Application Priority Data
Nov. 30, 2010 (TW) 99141415

(51) Int. Cl. H04R 5/00

(52) U.S. Cl. 381/17

(57) ABSTRACT

An audio processing device, including: an audio processing unit, for transforming a source audio signal into a first audio signal and a second audio signal, wherein if the source audio signal is an audio signal with multi-channels, the first audio signal is one of the multi-channels and the second audio signal is another one of multi-channels; a wireless communication unit, for outputting a coding signal according to the second audio signal; and a speaker unit, for outputting the first audio signal only.

### CROSS REFERENCE TO RELATED APPLICATIONS

This application claims priority of Taiwan Patent Application No. 99141415, filed on Nov. 30, 2010, the entirety of which is incorporated by reference herein.

### BACKGROUND OF THE INVENTION

1. Field of the Invention

The disclosure relates generally to devices for audio processing, and more particularly relates to multi-channel audio application systems with stereo efficacy.

2. Description of the Related Art

There must be at least two independent audio channels to generate stereo sound, and output the stereo sound via a pair of speakers disposed symmetrically. However, there is only one single speaker for most mobile phones or smart phones. Thus, they can not perform stereo sound efficacy.

Nowadays, mobile phones and smart phones use low pass filters, high pass filters and equalizers by an audio process chip, to transform digital signals into analog signals, separate left channel signals and right channel signals, and then output them to speakers for playing. However, space in mobile phones and smart phones are limited, when configuring for both left channel and right channel speakers. Thus, in conventional designs, mobile phones and smart phones usually transform audio signals into full-differential mono audio signal, and output them via a single speaker.

### BRIEF SUMMARY OF THE INVENTION

In an embodiment of an audio processing device, an audio processing device comprises: an audio processing unit, for transforming a source audio signal into a first audio signal and a second audio signal, wherein when the source audio signal is an audio signal with multiple channels, the first audio signal is one of the channels and the second audio signal is another one of the channels; a wireless communication unit, for outputting a coding signal according to the second audio signal; and a speaker unit, for outputting the first audio signal only.

In an embodiment of a multi-channel audio application system, a multi-channel audio application system comprises: a first device, which comprises a first audio processing unit, for transforming a source audio signal into a first audio signal and a second audio signal, wherein when the source audio signal is an audio signal with multiple channels, the first audio signal is one of the channels and the second audio signal is another one of the channels; a first wireless communication unit, for outputting a coding signal according to the second audio signal; and a first speaker unit, for outputting the first audio signal only; and a second device, which comprise a second wireless communication unit, for receiving the coding signal; a second audio processing unit, for generating a third audio signal according to the coding signal; and a speaker unit, for outputting the third audio signal.

In an embodiment of a multi-channel audio application method, a multi-channel audio application method comprises: matching a first device with a second device; transforming a source audio signal into a first audio signal and a second audio signal, and transmitting the second audio signal to the second device by the first device; outputting the first audio signal by the first device; and outputting the second audio signal by the second device.

### BRIEF DESCRIPTION OF DRAWINGS

The invention will become more fully understood by referring to the following detailed description with reference to the accompanying drawings, wherein:

FIG. 1 is a schematic diagram illustrating an embodiment of an audio processing device;

FIG. 2 is a schematic diagram illustrating an embodiment of a multi-channel audio application system;

FIG. 3 is a schematic diagram illustrating another embodiment of a multi-channel audio application system;

FIG. 4 is a flowchart of an embodiment of a method for the multi-channel audio application system shown in FIG. 2;

FIG. 5 is a flowchart of an embodiment of a method for the multi-channel audio application system shown in FIG. 2; and

FIG. 6 is a flowchart of an embodiment of a method for the multi-channel audio application system shown in FIG. 3.

### DETAILED DESCRIPTION OF THE INVENTION

The making and using of the embodiments of the present invention are discussed in detail below. It should be appreciated, however, that the embodiments provide many applicable inventive concepts that can be embodied in a wide variety of specific contexts. The specific embodiments discussed are merely illustrative of specific ways to make and use the invention, and do not limit the scope of the invention.

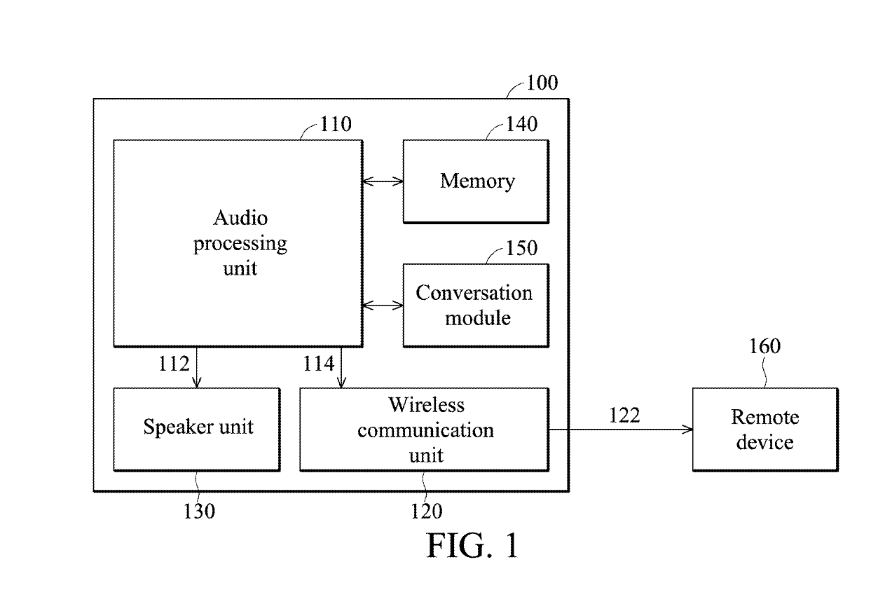

FIG. 1 is a schematic diagram illustrating an embodiment of an audio processing device 100. The audio processing device 100 comprises an audio processing unit 110, a wireless communication unit 120, a speaker unit 130, a memory 140, and a conversation module 150. The audio processing unit 110 receives an arbitrary source audio signal and transforms the source audio signal into an audio signal 112 and an audio signal 114. The wireless communication unit 120 processes matching with other devices, receives the audio signal 114, and transforms the audio signal 114 into a coding signal 122 for transmitting the content of the audio signal 114 to a remote device 160. The speaker unit 130 outputs the audio signal 112. The memory 140 stores the data of the source audio signal. The conversation module 150 provides the capability of external calling and receives the external audio as the source audio signal. Thus, the audio processing device 100 can transform the source audio signal into a plurality of audio signals, and transmit parts of the audio signals to an arbitrary remote device via the wireless communication unit 120 for playing. For example, the audio processing device 100 can transform the source audio signal with stereo sound into a left channel signal and a right channel signal, output the left channel signal, and transmit the right channel signal to a remote device for playing.

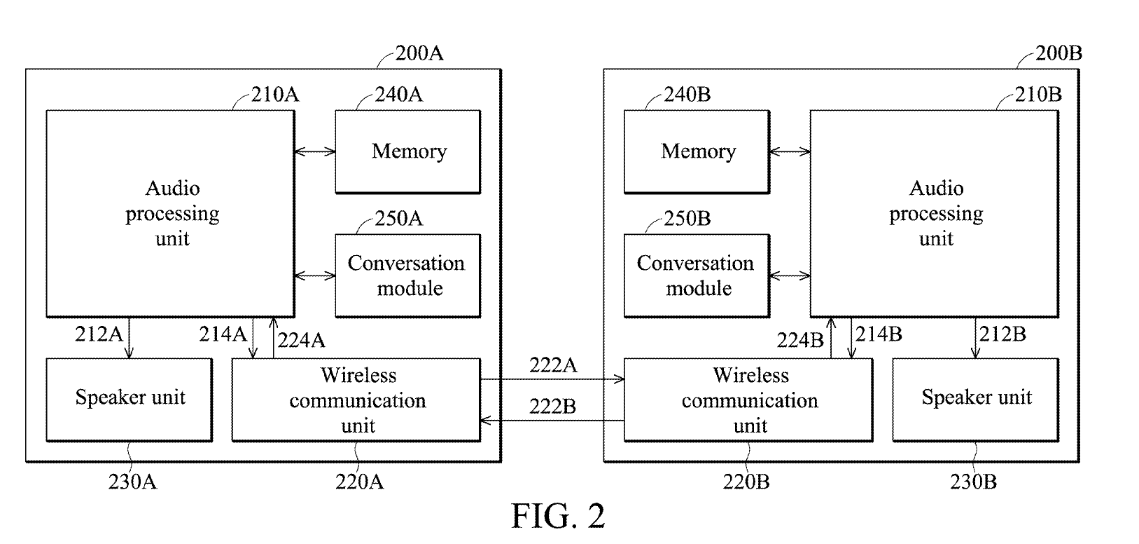

FIG. 2 is a schematic diagram illustrating an embodiment of a multi-channel audio application system. The multi-channel audio application system comprises an audio processing device 200A and an audio processing device 200B, wherein the audio processing device 200A comprises an audio processing unit 210A, a wireless communication unit 220A, a speaker unit 230A, a memory 240A, and a conversation module 250A, and the audio processing device 200B comprises an audio processing unit 210B, a wireless communication unit 220B, a speaker unit 230B, a memory 240B, and a conversation module 250B. The audio processing unit 210A receives an arbitrary source audio signal and transforms the source audio signal into an audio signal 212A and an audio signal 214A. The wireless communication unit 220A receives the audio signal 214A, and transforms the audio signal 214A into a coding signal 222A for transmitting the content of the audio signal 214A to the wireless communication unit 220B of the audio processing device 200B which has been matched, the audio processing unit 210B generates the audio signal 214B accordingly, and then outputs the audio signal 214B through the speaker unit 230B. The speaker unit 230A outputs the audio signal 212A. The audio processing device 200A and the audio processing device 200B can be hand-held communication devices such as mobile phones, smart phones, or PDAs. The wireless communication unit 220A and the wireless communication unit 220B can be infrared transmission, bluetooth transmission, WI-FI, or other wireless transmission interface. The memory 240A and memory 240B might store the data of source audio signal, or register data for the audio processing unit 210A and the audio processing unit 210B. The conversation module 250A and the conversation module 250B (for example, microphone) provide the capability of external calling or receiving the external audio of a user for the audio processing device 200A and the audio processing device 200B.

In the illustrated embodiment, if the source audio signal is two-channel audio, the audio signal 212A can be left-channel audio and the audio signal 214A can be right-channel audio, and vice versa. Further, the audio signal 212A and the audio signal 214A could be the same audio signal such as a left-channel audio signal or a right-channel audio signal. In another illustrated embodiment, if the source audio signal is more than two channels, the audio processing unit 210A transforms the multi-channel signal into a plurality of audio signals, and then assigns one of the audio signals to the audio signal 212A according to user requirements and then outputs it through the speaker unit 230A. Further, one or parts of the other audio signals is transformed into the audio signal 214A by the wireless communication unit 220A. Accordingly, a single audio processing device has only one speaker, but it can still play stereo audio or multi-channel audio with other audio processing devices by the method described above. For example, two audio processing devices could play two channel audios of a multi-channel audio, and seven audio processing devices could play each channel audio of the seven-channel audio. It is to be understood, although the audio processing device 200A transmits an audio signal with one channel audio of the source audio signal to the audio processing device 200B for playing in the embodiment described above, however, the audio processing device 200B could also transmit an audio signal with one channel audio of the source audio signal to the audio processing device 200A for playing according to the same method. In addition, the audio processing device 200A and the audio processing device 200B are the same construction in the embodiment, but the invention is not limited thereto. The audio processing device 200B could be any device which can receive and decode the coding signal 222A for playing.

In the illustrated embodiments, the source audio signal may be provided by the memory 240A of the audio processing device 200A, the conversation module 250A, or other units which could provide the source audio signal. For example, music data with multi-channel stored in the memory 240A, the audio signal received by the conversation module 250A, or the audio signal input via external line.

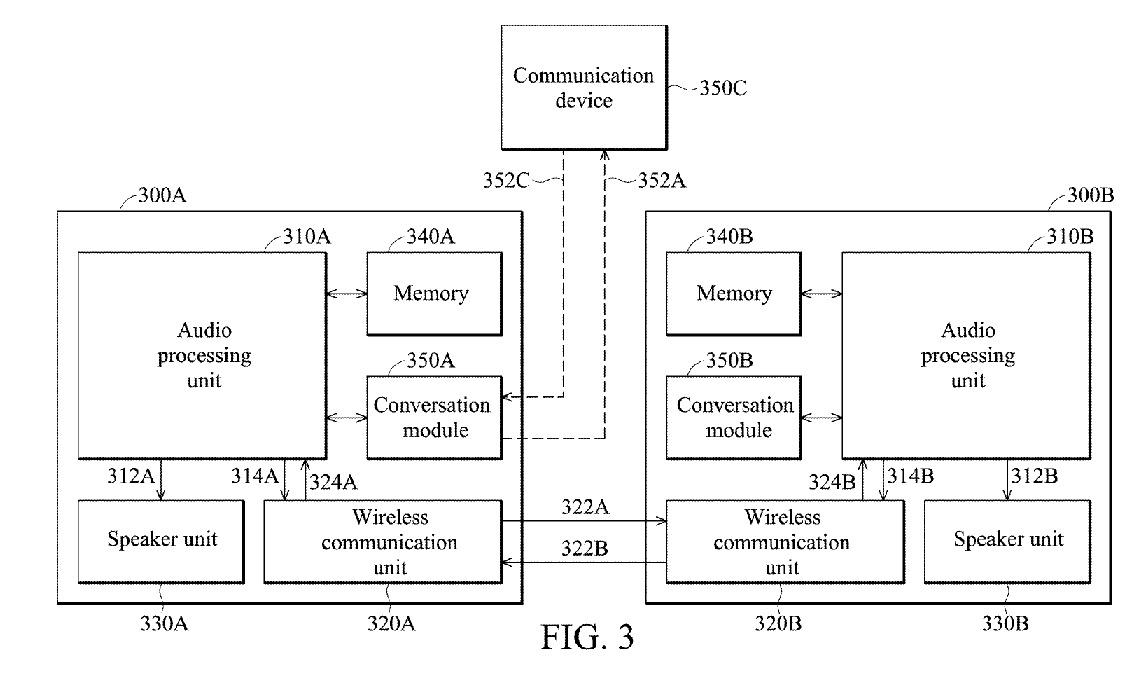

FIG. 3 is a schematic diagram illustrating another embodiment of a multi-channel audio application system. The multi-channel audio application system comprises an audio processing device 300A and an audio processing device 300B, wherein the audio processing device 300A comprises an audio processing unit 310A, a wireless communication unit 320A, a speaker unit 330A, a memory 340A, and a conversation module 350A, and the audio processing device 300B comprises an audio processing unit 310B, a wireless communication unit 320B, a speaker unit 330B, a memory 340B, and a conversation module 350B. A communication device 350C could be any devices that can process calling and proceeding a conversation, such as a telephone, a mobile phone, a network telephone, etc. In this embodiment, the audio processing unit 310A uses a conversation audio signal 352C received from the communication device 350C through the conversation module 350A as a source audio signal and transforms the source audio signal into an audio signal 312A and an audio signal 314A. Since the conversation audio signal is normally single channel audio, the audio signal 312A and the audio signal 314A could have the same audio content. The wireless communication unit 320A receives the audio signal 314A, and transforms the audio signal 314A into a coding signal 322A for transmitting the content of the audio signal 314A to the wireless communication unit 320B of the audio processing device 300B which has been matched, the audio processing unit 310B generates the audio signal 314B accordingly, and then outputs the audio signal 314B through the speaker unit 330B. Thus, the user could also hear the voice from the communication device 350C via the audio processing device 300B.

In the illustrated embodiment above, in order to process conversation with the third person (communication device 350C) by the audio processing device 300B, the conversation module 350B of the audio processing device 300B receives the voice from a user and transmits it to the audio processing unit 310B, and the wireless communication unit 320B receives the audio signal 314B from the audio processing unit 310B accordingly, transforms the audio signal 314B into a coding signal 322B, and transmits the coding signal 322B to the wireless communication unit 320A. And then the wireless communication unit 320A decodes the coding signal 322B to the audio signal 324A and transmits it to the audio processing unit 310A, the audio processing unit 310A generates a conversation audio 352A, and transmits the conversation audio 352A to the communication device 350C via the conversation module 350A. Thus, a plurality of the audio processing devices could process multiparty conversation or a telephone conference by the method describe above. For example, when an audio processing device processes conversation with a communication device, the other audio processing devices which have been matched with the audio processing device could also obtain the speaking voice from the communication device. Also, the other audio processing devices which have been matched with the audio processing device could proceeding a conversation with the communication device via the audio processing device.

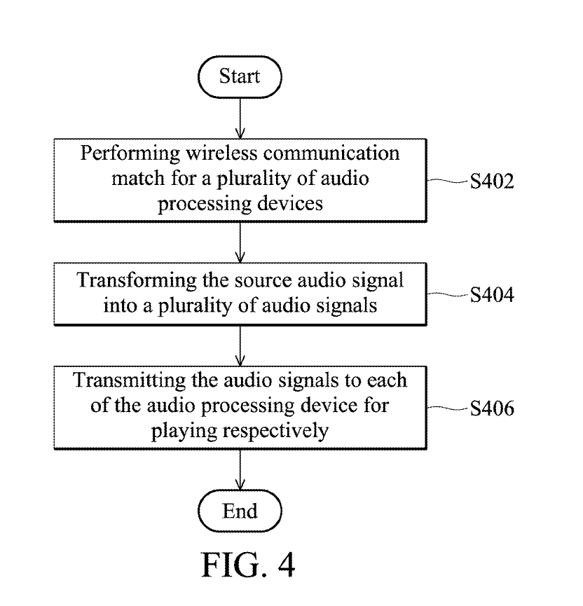

FIG. 4 is a flowchart of an embodiment of a method for the multi-channel audio application system (including an audio processing device 200A and an audio processing device 200B) shown in FIG. 2. In step S402, a wireless communication match is performed to check whether the collective playing is ready or not. In step 404, the audio processing device 200A transforms the source audio signal into an audio signal 212A and an audio signal 214A. In step 406, the wireless communication unit 220A transmits the audio signal 214A to the audio processing device 200B for playing, and the speaker unit 230A outputs the audio signal 212A simultaneously. Thus, two audio processing devices each having a single speaker could output the audio signal with multi-channels and perform stereo efficacy or surround sound efficacy.

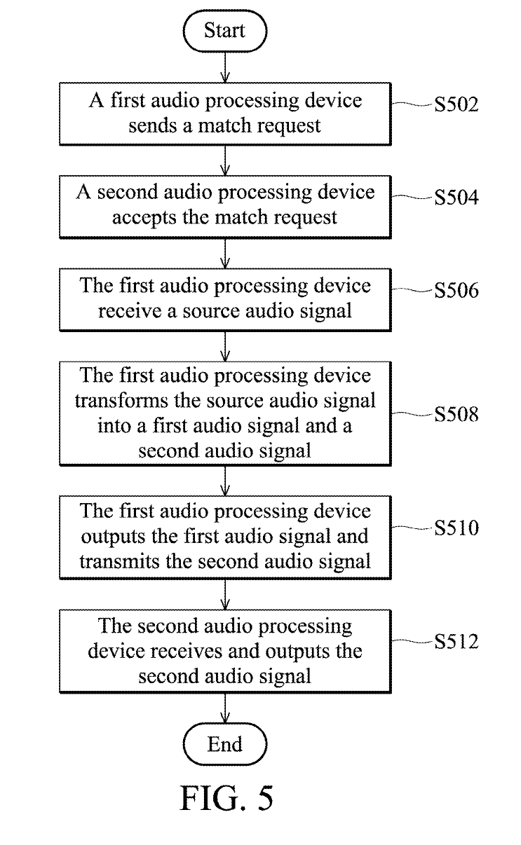

FIG. 5 is a flowchart of an embodiment of a method for the multi-channel audio application system shown in FIG. 2. In step S502, the audio processing device 200A sends a match request to the audio processing device 200B. In step S504, the audio processing device 200B accepts the match request to perform the wireless communication match between the audio processing device 200A and the audio processing device 200B. In step S506, the audio processing device 200A begins to receive a source audio signal. In step S508, the audio processing device 200A transforms the source audio signal into an audio signal 212A and an audio signal 214A. In step S510, the audio processing device 200A outputs the audio signal 212A and transforms the audio signal 214A into the coding signal 222A in order to transmit it to the audio processing device 200B. In step S512, the audio processing device 200B receives the coding signal 222A and transforms it into the audio signal 214 for playing.

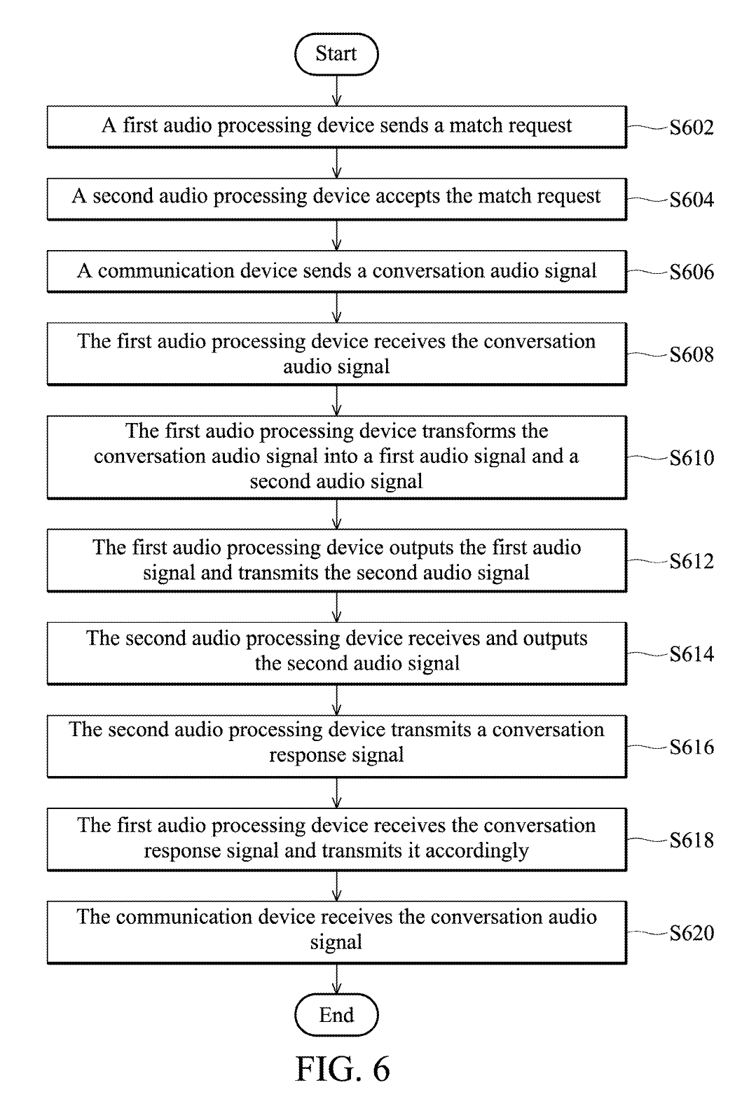

FIG. 6 is a flowchart of an embodiment of a method for the multi-channel audio application system shown in FIG. 3. In step S602, the audio processing device 300A sends a match request to the audio processing device 300B. In step S604, the audio processing device 300B accepts the match request to perform the wireless communication match between audio processing device 300A and the audio processing device 300B, and it also checks whether the collective playing is ready or not. In step S606, when the audio processing device 300A proceeds a conversation with the communication device 350C, the communication device 350C sends the conversation audio signal 352C to the audio processing device 300A. In step S608, the audio processing device 300A receives the conversation audio signal 352C. In step S610, the audio processing device 300A transforms the conversation audio signal 352C as the source audio signal into an audio signal 312A and an audio signal 314A. In step S612, the audio processing device 300A outputs the audio signal 312A and transforms the audio signal 314A into the coding signal 322A in order to transmit it to the audio processing device 300B. In step S614, the audio processing device 300B receives the coding signal 322A and transforms it into the audio signal 314 for playing. In step S616, the audio processing device 300B transforms an arbitrary audio signal as a conversation response signal (such as, voice of a user) into the coding signal 322B for transmitting it to the audio processing device 300A. In step S618, the audio processing unit 310A generates a conversation audio signal 352A, and transmits the conversation audio signal 352A to the communication device 350C. In step S620, the communication device 350C receives the conversation audio signal 352A and outputs it accordingly. It is to be understood that there are two audio processing devices which process multiparty conversation in this embodiment, but those who are skilled in this technology can still process multiparty conversation of more than two audio processing devices by the method described above.

Those who are skilled in this technology can still process deletion, addition, or change the order of the steps described above without departing from the scope and spirit of this invention. For example, if the user of the audio processing device 300B does not proceed a conversation with the third person, then the step S616 to S620 could be omitted, and if the user of the audio processing device 300B proceeds a conversation with to the third person without receiving the audio signal of the third person, then the step S606 to S614 could be omitted.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An audio processing device, comprising:
an audio processing unit, for transforming a source audio signal into a first audio signal and a second audio signal, wherein when the source audio signal is an audio signal with multiple channels, the first audio signal is one of the channels and the second audio signal is another one of the channels;
a wireless communication unit, for outputting a coding signal according to the second audio signal; and
a speaker unit, for outputting the first audio signal only.

2. The audio processing device of claim 1, wherein the coding signal is used to be outputted to at least one remote device, and the at least one remote device is arranged for generating a third audio signal according to the coding signal and outputting the third audio signal.

3. The audio processing device of claim 1, wherein the wireless communication unit is a bluetooth wireless communication unit, and is arranged for outputting the second audio signal via a bluetooth protocol.

4. A multi-channel audio application system, comprising:
a first device, comprising:
a first audio processing unit, for transforming a source audio signal into a first audio signal and a second audio signal, wherein when the source audio signal is an audio signal with multiple channels, the first audio signal is one of the channels and the second audio signal is another one of the channels;
a first wireless communication unit, for outputting a coding signal according to the second audio signal; and
a first speaker unit, for outputting the first audio signal only; and
a second device, comprising:
a second wireless communication unit, for receiving the coding signal;
a second audio processing unit, for generating a third audio signal according to the coding signal; and
a speaker unit, for outputting the third audio signal.

5. The multi-channel audio application system of claim 4, wherein each of the first device and the second device is a hand-held communication device.

6. The multi-channel audio application system of claim 4, wherein each of the first wireless communication unit and the second audio processing unit is a bluetooth wireless communication unit.

7. The multi-channel audio application system of claim 4, further comprising a third device, for proceeding a conversation with the first device, and the first device further comprising a first conversation module, for receiving a first conversation audio signal of the third device and for transmitting the first conversation audio signal to the first audio processing unit as the source audio signal.

8. The multi-channel audio application system of claim 7, wherein the second device is further arranged for sending a second conversation audio signal to the first device by the second wireless communication unit, and the first device is further arranged for sending a first conversation audio response signal to the third device according to the second conversation audio signal.

9. A multi-channel audio application method, comprising:
matching a first device with the second device;
transforming a source audio signal into a first audio signal and a second audio signal, and transmitting the second audio signal to the second device by the first device;
outputting the first audio signal by the first device; and
outputting the second audio signal by the second device.

10. The multi-channel audio application method of claim 9, wherein when the source audio signal is an audio signal with multiple channels, the first audio signal is one of the channels and the second audio signal is another one of the channels.

11. The multi-channel audio application method of claim 9, further comprising:
using a conversation module of the first device to proceeding a conversation with to a third device; and
the first device receiving a first conversation audio signal of the third device as the source audio signal.

12. The multi-channel audio application method of claim 11, further comprising:
receiving a second conversation audio signal from the second device by the first device; and
sending a first conversation audio response signal to the third device by the first device according to the second conversation audio signal.
